(19) United States
(12) Patent Application Publication
(10) Pub. No.: US 2025/0261589 A1
(43) Pub. Date: Aug. 21, 2025

(54) HARVESTING ASSEMBLY OF AN AGRICULTURAL HARVESTER

(71) Applicant: CNH Industrial Brasil Ltda., Nova Lima (BR)

(72) Inventors: Daniel Rohrer Pereira, Piracicaba-SP (BR); Jean Carlos Pereira de Camargo, Piracicaba-SP (BR); Alessandro Roberto Pereira, Piracicaba-SP (BR)

(21) Appl. No.: 19/055,157

(22) Filed: Feb. 17, 2025

(30) Foreign Application Priority Data
Feb. 19, 2024 (BR) 10 2024 003135-0

(51) Int. Cl. A01D 41/14; A01D 41/127; A01D 57/01

(52) U.S. Cl. CPC A01D 41/14; A01D 41/127; A01D 57/01

(57) ABSTRACT

An agricultural harvester includes a cutter assembly configured to sever crop material. Additionally, the harvester includes a divider shoe configured to direct crop material toward the cutter assembly. Furthermore, the crop divider includes a first feed roller and a second feed roller. The second feed roller extends between first and second ends. The first end of the second feed roller is pivotably coupled to the shoe such that the position of the roller is adjustable relative to the first feed roller to direct the crop material toward the cutter assembly. Moreover, the harvester includes an actuator coupled between the second feed roller and the forward frame of the harvester. The actuator is configured to adjust the position of the second feed roller relative to the first feed roller to control the quantity of crop directed toward the cutter assembly.

### CROSS-REFERENCE TO RELATED APPLICATIONS

The present application is based upon and claims the right of priority to Brazilian Patent Application No. BR 10 2024 003135-0, filed Feb. 19, 2024, the disclosure of which is hereby incorporated by reference herein in its entirety for all purposes.

### FIELD OF THE INVENTION

The present disclosure relates generally to agricultural harvesters and, more particularly, to a harvesting assembly of an agricultural harvester.

### BACKGROUND OF THE INVENTION

Typically, agricultural harvesters include an assembly of processing equipment for processing harvested crop materials. For instance, a sugarcane harvester typically includes one or more crop dividers with feed rollers configured to gather sugarcane stalks therebetween and direct the gathered sugarcane stalks toward a base cutter assembly which severs the sugarcane stalks. The severed sugarcane stalks are then conveyed via a conveyor assembly to a chopper assembly that cuts or chops the sugarcane stalks into pieces or billets (e.g., 6 inch cane sections). The processed crop material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

The feed rollers of the crop dividers typically work in conjunction with each other to gather the sugarcane stalks. In this respect, the feed rollers raise the sugarcane stalks and direct/pull the raised stalks toward the base cutter assembly. The higher that the stalks are raised, the more, or greater portion of, stalk material is directed/pulled between the feed rollers and toward the base cutter assembly. Conversely, the lower that the stalks are raised, the less, or lesser portion of, stalk material is directed/pulled between the feed rollers and toward the base cutter assembly. While current feed rollers work well, further improvements are needed.

Accordingly, a harvesting assembly of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural harvester. The agricultural harvester includes a chassis and a forward frame supported by the chassis. Additionally, the agricultural harvester includes a cutter assembly supported on the forward frame and configured to sever crop material as the agricultural harvester traverses a field. Furthermore, the agricultural harvester includes a divider shoe coupled to the forward frame and configured to direct the crop material toward the cutter assembly as the agricultural harvester traverses the field. Moreover, the agricultural harvester includes a first feed roller coupled to the forward frame. Additionally, the agricultural harvester includes a second feed roller extending between a first end and a second end. The first end of the second feed roller is pivotably coupled to the divider shoe such that a position of the second feed roller is adjustable relative to the first feed roller. Furthermore, the second feed roller is configured to operate in conjunction with the first feed roller to direct the crop material toward the cutter assembly as the agricultural harvester traverses the field. Moreover, the agricultural harvester includes an actuator coupled between the second feed roller and the forward frame. The actuator is configured to adjust the position of the second feed roller relative to the first feed roller to control a quantity of the crop material that is directed toward the cutter assembly.

In another aspect, the present subject matter is directed to a harvesting assembly of an agricultural harvester. The harvesting assembly includes a cutter assembly configured to sever crop material as the agricultural harvester traverses a field. Furthermore, the harvesting assembly includes a divider shoe configured to direct the crop material toward the cutter assembly as the agricultural harvester traverses the field. Moreover, the harvesting assembly includes a first feed roller. Additionally, the harvesting assembly includes a second feed roller extending between a first end and a second end. The first end of the second feed roller is pivotably coupled to the divider shoe such that a position of the second feed roller is adjustable relative to the first feed roller. Furthermore, the second feed roller is configured to operate in conjunction with the first feed roller to direct the crop material toward the cutter assembly as the agricultural harvester traverses the field. Moreover, the harvesting assembly includes an actuator coupled between the second feed roller and a forward frame of the agricultural harvester. The actuator is configured to adjust the position of the second feed roller relative to the first feed roller to control a quantity of the crop material that is directed toward the cutter assembly.

In another aspect, the present subject matter is directed to a method for controlling the operation of an agricultural harvester. The agricultural harvester includes a divider shoe configured to direct crop material toward a cutter assembly as the agricultural harvester traverses the field. Additionally, the agricultural harvester includes a first feed roller. Furthermore, the agricultural harvester includes a second feed roller extending between a first end and a second end. The first end of the second feed roller is pivotably coupled to the divider shoe such that a position of the second feed roller is adjustable relative to the first feed roller. The method includes receiving, with a computing system, a first operator input to pivot the second feed roller toward a raised position. Furthermore, the method includes controlling, with the computing system, an operation of an actuator configured to pivot the second feed roller relative to the first feed roller between a lowered position and the raised position such that the second feed roller is pivoted toward the raised position based on the received first operator input. Moreover, the method includes receiving, with the computing system, a second operator input to pivot the second feed roller toward the lowered position. Additionally, the method includes controlling, with the computing system, the operation of the actuator such that the second feed roller is pivoted relative to the first feed roller toward the lowered position based on the received second operator input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a front view of a harvesting assembly of an agricultural harvester in accordance with aspects of the present subject matter;

FIG. 3 illustrates a section view of the harvesting assembly of the agricultural harvester shown in FIG. 2 taken about section line 3-3, in accordance with aspects of the present subject matter;

FIG. 4 illustrates a schematic view of a system for controlling the operation of an agricultural harvester in accordance with aspects of the present subject matter; and

FIG. 5 illustrates a flow diagram of one embodiment of a method for controlling the operation of an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural harvester and a related system and a related method for controlling the operation of a harvester, such as of a sugarcane harvester. As will be described below, the harvester includes a chassis and a forward frame (sometimes referred to as a cutter frame) supported by the chassis. The harvester further includes one or more cutter assemblies supported by the forward frame and configured to sever crop material as the harvester traverses the field. Additionally, the harvester includes a divider shoe coupled to the forward frame and configured to direct the crop material toward the cutter assembly as the agricultural harvester traverses the field. For example, the crop shoe may act as a wedge to push stalks of sugarcane toward the cutter assembly.

Moreover, the harvester includes a first feed roller and a second feed roller configured to operate in conjunction with each other to direct the crop material toward the cutter assembly as the harvester traverses the field. As such, the second feed roller may extend between first and second ends with the first end being pivotably coupled to the divider shoe at a pivot joint such that the position of the second feed roller is adjustable relative to the first feed roller.

In several embodiments, one or more actuators of the harvester may be configured to adjust the position of the second feed roller relative to the first feed roller to control the quantity or the portion of the crop material that is directed toward the cutter assembly. The actuator(s) is coupled between the second feed roller and the forward frame of the harvester and may be configured to adjust the position of the second feed roller relative to the first feed roller by pivoting the second feed roller about the pivot joint between a lowered position and a raised position. Moreover, the operation of the actuator may be selectively controlled to adjust the position of the second feed roller relative to the first feed roller to control the quantity of the crop material that is directed toward the cutter assembly. For example, in some embodiments, the operation of the actuator is selectively controlled by one or more computing systems based on an operator input.

Adjusting the position of a feed roller relative to a different feed roller improves the operation of the harvester. Specifically, the feed rollers work in conjunction with each other to gather the crop material (e.g., stalks). In this respect, the feed rollers raise the sugarcane stalks and direct/pull the raised stalks toward the base cutter assembly. The higher that the stalks are raised, the greater portion of the stalk material is directed/pulled between the feed rollers and toward the base cutter assembly. Conversely, the lower that the stalks are raised, the lesser portion of the stalk material is directed/pulled between the feed rollers and toward the base cutter assembly. Conventional feed rollers are rigidly coupled to the forward frame of the agricultural harvesters. As such, the position of the feed rollers cannot be adjusted (e.g., raised, lowered) to control the height of the crop material (e.g., stalks) and, thus, the quantity/portion of the crop material (e.g., stalks) gathered and directed toward the base cutter assembly. However, the harvester of the present disclosure includes an actuator configured to adjust the position of a second feed roller relative to a first feed roller between a raised and lowered position. In this respect, the quantity/portion of the crop material (e.g., stalks) that is directed toward the cutter assembly can be controlled. This, in turn, allows the maximum portion of the crop material to be harvested without overloading the harvester with crop material and, thus, slowing down harvesting operations.

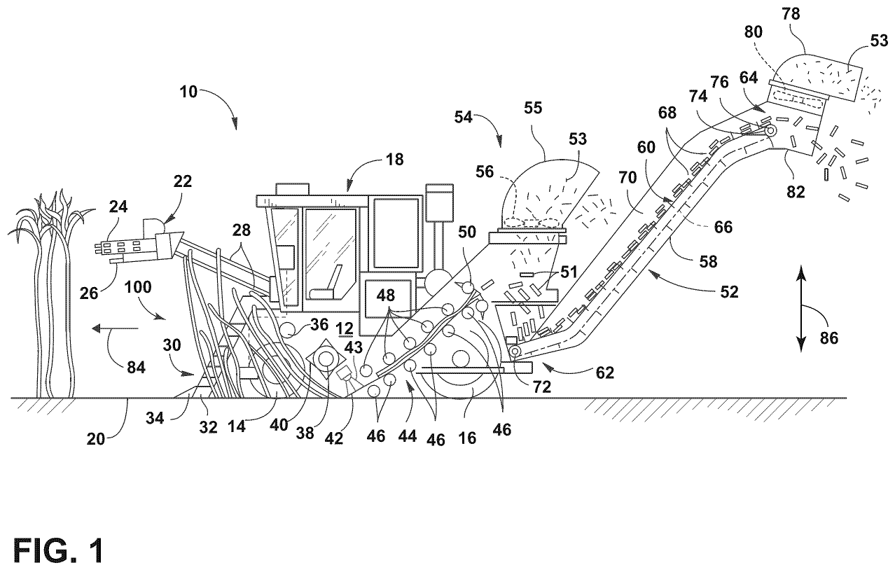

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame or chassis 12, a pair of front wheels 14, a pair of rear wheels 16, and an operator's cab 18. The harvester 10 may also include a primary source of power (e.g., an engine mounted on the chassis 12) which powers one or both pairs of the wheels 14, 16 via a transmission (not shown) such that the harvester 10 moves in a direction of travel (as indicated by arrow 84). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging crop material, such as sugarcane as the cane is harvested from an agricultural field 20. The harvester 10 may include a topper assembly 22 positioned at its front end to intercept sugarcane as the harvester 10 is moved in the forward direction. As shown, the topper assembly 22 may include both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 may be adjustable via a pair of arms 28 hydraulically raised and lowered, as desired, by the operator. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10.

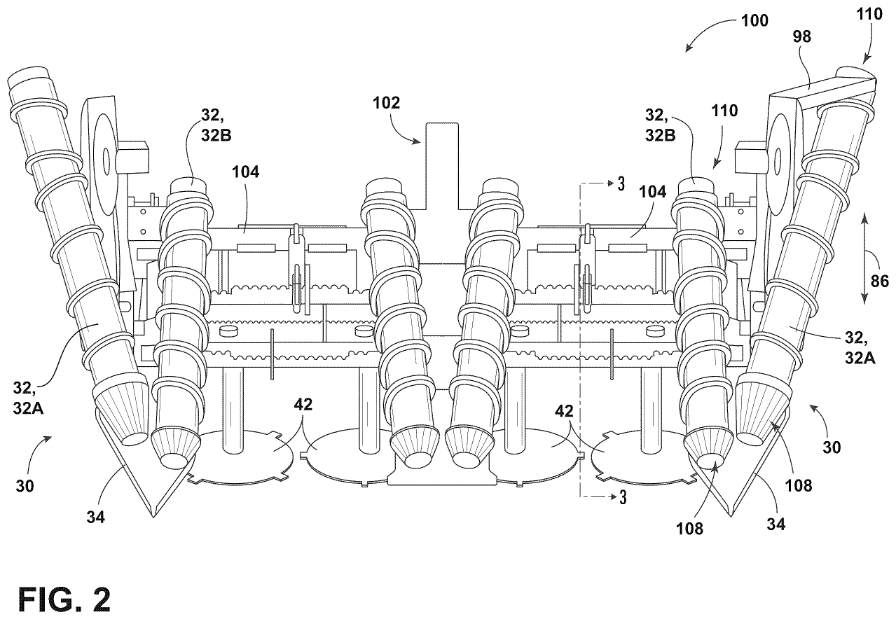

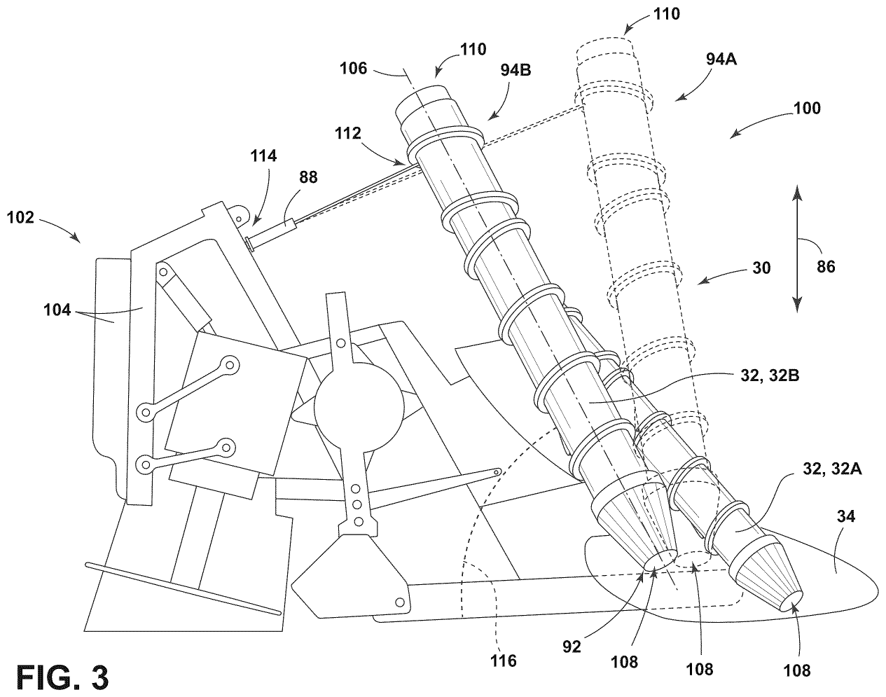

The harvester 10 may further include a harvesting assembly 100 including one or more crop dividers 30 that extend upwardly and rearwardly from the field 20. In general, the crop divider(s) 30 may include two or more spiral feed rollers 32. For example, as will be described below, the crop divider(s) 30 may include one or more first spiral feed rollers 32A (FIGS. 2, 3) and one or more second spiral feed rollers 32B (FIGS. 2, 3). Additionally, the harvesting assembly 100 may include one or more ground or divider shoes 34, each positioned below the spiral feed rollers 32 in a vertical direction (as indicated by arrow 86) relative to the direction of travel 84. The divider shoe(s) 34 are configured to assist the crop divider(s) 30 in gathering the sugarcane stalks for harvesting by directing the stalks toward a base cutter assembly 42 of the harvesting assembly 100, which will be described below, as the harvester 10 traverses the field. As the stalks enter the crop divider(s) 30, the divider shoe(s) 34 may set the operating width to determine the quantity of sugarcane directed toward the base cutter assembly 42. The spiral feed rollers 32 then gather the stalks to allow a knock-down roller 36 to bend the stalks downwardly in conjunction with the action of a finned roller 38. The knock-down roller 36 is positioned near the front wheels 14 and the finned roller 38 positioned behind or downstream of the knock-down roller 36. As the knock-down roller 36 is rotated, the sugarcane stalks being harvested are knocked down. The finned roller 38 may include a plurality of intermittently mounted fins 40 that assist in forcing the sugarcane stalks downwardly. For instance, as the finned roller 38 is rotated, the sugarcane stalks that have been knocked down by the knock-down roller 36 are separated and further knocked down by the finned roller 38 as the harvester 10 continues to be moved in the forward direction relative to the field 20.

Once the stalks are angled downwardly as shown in FIG. 1, the base cutter assembly 42 of the harvesting assembly 100 may then sever the base of the stalks from field 20. The base cutter assembly 42 is positioned behind or downstream of the finned roller 38. As is generally understood, the base cutter assembly 42 may include knives or blades 43 for severing the sugarcane stalks as the cane is being harvested. The blades 43, located on the periphery of the base cutter assembly 42, may be rotated by a hydraulic motor (not shown) powered by the vehicle's hydraulic system. Moreover, in several embodiments, the blades may be angled downwardly to sever the base of the sugarcane as the cane is knocked down by the finned roller 38. Additionally, the height of the base cutter assembly 42 (e.g., of the blades 43) above the field 20 may be adjustable to maintain the cutting height for harvesting the sugarcane at or below the particular cutting height.

The severed stalks are then, by movement of the harvester 10, directed to a conveyor assembly 44 located downstream of the base cutter assembly 42 for moving the severed stalks of sugarcane from base cutter assembly 42 along the processing path. As shown in FIG. 1, the conveyor assembly 44 may include a plurality of bottom rollers 46 and a plurality of opposed, top pinch rollers 48. The harvested sugarcane may be pinched between various bottom and top rollers 46, 48 to make the sugarcane stalks more uniform and to convey the harvested sugarcane rearwardly (downstream) during transport. As the sugarcane is transported through the conveyor assembly 44, debris (e.g., rocks, dirt, and/or the like) may be allowed to fall through bottom rollers 46 onto the field 20.

At the downstream end of the conveyor assembly 44 (e.g., adjacent to the rearward-most bottom and top rollers 46, 48), a chopper assembly 50 may cut or chop the compressed sugarcane stalks. In general, the chopper assembly 50 may be used to cut the sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, a primary extractor assembly 54 may be provided to help separate pieces of debris 53 (e.g., dust, dirt, leaves, etc.) from the sugarcane billets 51 before the billets 51 are received by the elevator assembly 52. The primary extractor assembly 54 is located immediately behind or downstream of the chopper assembly 50 relative to the flow of harvested crop and is oriented to direct the debris 53 outwardly from the harvester 10. The primary extractor assembly 54 may include an extractor fan 56 mounted within a housing 55 for generating a suction force or vacuum sufficient to separate and force the debris 53 through an inlet of the housing 55 into the primary extractor assembly 54 and out of the harvester 10 via an outlet of the housing 55. The separated or cleaned billets 51 are heavier than the debris 53 being expelled through the extractor 54, so the billets 51 may fall downward to the elevator assembly 52 instead of being pulled through the primary extractor assembly 54.

As further shown in FIG. 1, the elevator assembly 52 may include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Additionally, in some embodiments, pieces of debris or trash 53 (e.g., dust, dirt, leaves, etc.) separated from the elevated sugarcane billets 51 may be expelled from the harvester 10 through a secondary extractor assembly 78 coupled to the rear end of the elevator housing 58. For example, the debris 53 expelled by the secondary extractor assembly 78 may be debris remaining after the billets 51 are cleaned and debris 53 expelled by the primary extractor assembly 54. As shown in FIG. 1, the secondary extractor assembly 78 may be located adjacent to the distal end 64 of the elevator 60 and may be oriented to direct the debris 53 outwardly from the harvester 10. Additionally, an extractor fan 80 may be mounted at the base of the secondary extractor assembly 78 for generating a suction force or vacuum sufficient to pick up the debris 53 and force the debris 53 through the secondary extractor assembly 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

Referring now to FIGS. 2 and 3, various views of a harvesting assembly 100 suitable for use with a harvester, such as the harvester 10, are illustrated in accordance with aspects of the present subject matter. Particularly, FIG. 2 illustrates a front view of the harvesting assembly 100 of the harvester 10. Additionally, FIG. 3 illustrates a section view of the harvesting assembly 100 of the harvester 10 taken about section line 3-3 in FIG. 2.

As particularly shown in FIGS. 2 and 3, the harvesting assembly 100 includes a forward frame 102 including a frame member 104, where the frame member 104 may be supported on the chassis 12 (FIG. 1) of the harvester 10. The frame member 104 is fixed relative to the chassis 12 (FIG. 1) of the harvester 10, such that the forward frame 102 is fixed relative to the chassis 12. The frame member 104 may generally support the various components of the harvester 10 relative to the chassis 12 (FIG. 1). For instance, as shown in FIG. 2, the harvesting assembly 100 includes two crop dividers 30 and corresponding ground shoes 34. Each crop divider 30 may be movably coupled at the forward end of the frame member 104 relative to the direction of travel 84. For example, each crop divider 30 may be supported by a respective linkage assembly relative to the frame member 104. As such, the crop dividers 30 may move up and down in the vertical direction 86, independently of each other, as the divider shoes 34 move along the surface of the field 20. It should be appreciated that, while the harvesting assembly 100 is shown as including two crop dividers 30, the harvesting assembly 100 may include any other suitable number of crop dividers 30, such as one crop divider 30 or three or more crop dividers 30. Similarly, it should be appreciated that, while each crop divider 30 is shown as having two spiral feed rollers 32, any other suitable number of spiral feed rollers 32 for each crop divider 30 may instead be provided, such as three or more spiral feed rollers 32 per crop divider 30.

Additionally, as shown in FIGS. 2 and 3, the first spiral feed rollers 32A of the crop dividers 30 may be fixed relative to the forward frame 102 such that an angular orientation of the first spiral feed rollers 32A relative to the forward frame 102 are fixed. In this respect, the first spiral feed rollers 32A are fixed such that an angle 116 defined between each of the first spiral feed rollers 32A and the forward frame 102 remains unchanged. As such, the first spiral feed rollers 32A each extend between a first end 108 and a second end 110. A bracket assembly 98 of the forward frame 102 may be coupled to the second ends 110 of the first spiral feed rollers 32A. Furthermore, the divider shoes 34, which are fixedly coupled to the forward frame 102, are coupled to the first ends 108 of the first spiral feed rollers 32A.

Furthermore, as shown in FIG. 3, the second spiral feed roller 32B is pivotably coupled to the divider shoe 34 such that a position of the second spiral feed roller 32B is adjustable relative to the first spiral feed roller 32A. For example, the second spiral feed roller 32B extends between a first end 108 and a second end 110, the first end 108 of which may be pivotably coupled to the divider shoe 34 at a pivot joint 92 such that the second spiral feed roller 32B is configured to pivot about the pivot joint 92 relative to the first spiral feed roller 32A. As shown in FIG. 3, the second spiral feed roller 32B may be pivoted about the pivot joint 92 such that the second spiral feed roller 32B is adjusted between a raised position 94A and a lowered position 94B relative to the fist spiral feed roller 32A. When the second spiral feed roller 32B is adjusted toward the raised position 94A relative to the first feed roller 32A, the second end 110 of the second spiral feed roller 32B is moved upward in the vertical direction 86. Conversely, when the second spiral feed roller 32B is adjusted toward the lowered position 94B relative to the first feed roller 32A, the second end 110 of the second spiral feed roller 32B is moved downward in the vertical direction 86.

As the harvester 10 traverses the field 20, the second spiral feed roller(s) 32B are configured to operate in conjunction with the first spiral feed roller(s) 32A to direct the crop material (e.g., stalks) toward the base cutter assembly 42. In this respect, the first spiral feed roller(s) 32A and the second spiral feed roller(s) 32B may rotate about a central axis 106 to raise the crop material (e.g., stalks) in the vertical direction 86 and pull the raised crop material (e.g., stalks) toward the base cutter assembly 42. When the second spiral feed roller(s) 32B is adjusted to the raised position 94A, the crop material (e.g. stalks) are raised higher in the vertical direction 86 than when the second spiral feed roller(s) 32B is adjusted to the lowered position 94B. As such, the first spiral feed roller(s) 32A and the second spiral feed roller(s) 32B direct greater portions of the crop material (e.g., stalks) toward the base cutter assembly 42 when the second spiral feed roller(s) 32B are in the raised position 94A than the lowered position 94B.

Moreover, the harvesting assembly 100 includes one or more actuators 88 configured to adjust the position of the second spiral feed roller(s) 32B relative to the first spiral feed roller(s) 32A. The actuator(s) 88 may be coupled between the second spiral feed roller(s) 32B and the forward frame 102 and configured to pivot the second spiral feed roller(s) 32B about the pivot joint 92 between the raised position 94A and the lowered position 94B. For example, in one embodiment, the actuator(s) 88 extends between a first end 112 and a second end 114. The second end(s) 114 of the actuator(s) 88 is coupled to the forward frame 102. The first end(s) 112 of the actuator(s) 88 is coupled to the second spiral feed roller(s) 32B between the second end 110 of the second spiral feed roller(s) 32B and a position on the second spiral feed roller(s) 32B halfway between the first and second ends 108, 110 of the second spiral feed roller 32B. In this respect, the potential raised position 94A of the second spiral feed roller 32B and, thus, the potential quantity/portion of crop material (e.g., stalks) directed toward the base cutter assembly 42 is maximized. As will be described below, an operation of the actuator(s) 88 is selectively controlled to adjust the position of the second spiral feed roller(s) 32B relative to the first spiral feed roller(s) 32A.

In general, the actuator(s) 88 may correspond to any suitable actuator configured to adjust the position of the second spiral feed roller(s) 32B relative to the first spiral feed roller(s) 32A. As shown in FIGS. 2 and 3, the actuator(s) 88 is configured as a fluid-filled actuator(s), such as a hydraulic actuator(s) or a pneumatic actuator(s). However, it should be appreciated that the actuator(s) 88 may be configured as any suitable actuator(s) configured to adjust the position of the second spiral feed roller(s) 32B relative to the first spiral feed roller(s) 32A.

Furthermore, the harvesting assembly 100 may include any number of actuators 88 configured to adjust the position of the second spiral feed roller(s) 32B relative to the first spiral feed roller(s) 32A.

Adjusting the position of the second spiral feed roller(s) 32B relative to the first spiral feed roller(s) 32A allows the crop material (e.g., stalks) to be raised and lowered. The higher that the crop material (e.g., stalks) is raised, the greater portion of the crop material (e.g., stalks) is directed/pulled between the first and second spiral feed rollers 32A, 32B and toward the base cutter assembly 42. Conversely, the lower that the crop material (e.g., stalks) are raised, the lesser portion of the crop material (e.g., stalks) is directed/pulled between the first and second spiral feed rollers 32A, 32B and toward the base cutter assembly 42. In this respect, the quantity/portion of the crop material (e.g., stalks) that is directed toward the base cutter assembly 42 can be controlled. This, in turn, allows the maximum portion of the crop material to be harvested without overloading the harvester 10 with crop material and, thus, slowing down harvesting operations.

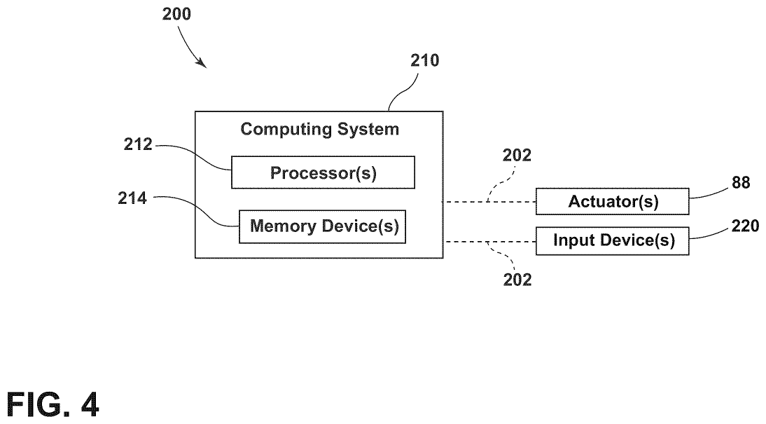

Referring now to FIG. 4, a schematic view of a system 200 for controlling the operation of an agricultural harvester is illustrated in accordance with aspects of the present subject matter. In general, the system 200 will be described with reference to the agricultural harvester 10 described with reference to FIGS. 1-3. However, it should be appreciated by those of ordinary skill in the art that the disclosed system 200 may generally be utilized with agricultural harvesters having any other suitable harvester configuration.

Moreover, the system 200 includes a computing system 210 communicatively coupled to one or more components of the agricultural harvester 10 and/or the system 200 to allow the operation of such components to be electronically or automatically controlled by the computing system 210. For instance, the computing system 210 may be communicatively coupled to the actuator(s) 88 via a communicative link 202. As such, the computing system 210 may be configured to control the operation of the actuator(s) 88 to adjust the position of the second spiral feed roller 32B relative to the first spiral feed roller 32A. Additionally, the computing system 210 may be communicatively coupled to any other suitable components of the harvester 10 and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the harvester 10, itself, or the computing system 210 may correspond to a separate processing device. For instance, in one embodiment, the computing system 210 may form all or part of a separate plug-in module that may be installed in association with the harvester 10 to allow for the disclosed systems to be implemented without requiring additional software to be uploaded onto existing control devices of the harvester 10.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

In addition, the system 200 may also include one or more input devices 220. More specifically, the input device(s) 220 may be configured to receive inputs (e.g., inputs to pivot the second spiral feed roller 32B) from the operator. For example, in several embodiments, the input device(s) 220 may be configured as a user interface(s). The user interface(s) may include a touchscreen(s), keypad(s), touchpad(s), knob(s), button(s), slider(s), switch(s), mice, microphone(s), and/or the like, which are configured to receive inputs from the operator. Such inputs may be used by the computing system 210 for use in pivoting the second spiral feed roller 32B. Moreover, the user interface(s) may include one or more feedback devices (not shown), such as display screens, speakers, warning lights, and/or the like, which are configured to provide feedback from the computing system 210 (e.g., feedback associated with the position of the second spiral feed roller 32B) to the operator. As such, the input device(s) 220 may, in turn, be communicatively coupled to the computing system 210 via the communicative link 202 to permit the feedback to be transmitted from the computing system 210 to the input device(s) 220.

Additionally, the input device(s) 220 may be mounted or otherwise positioned within the operator's cab 18. However, in alternative embodiments, the input device(s) 220 may mounted at any other suitable location.

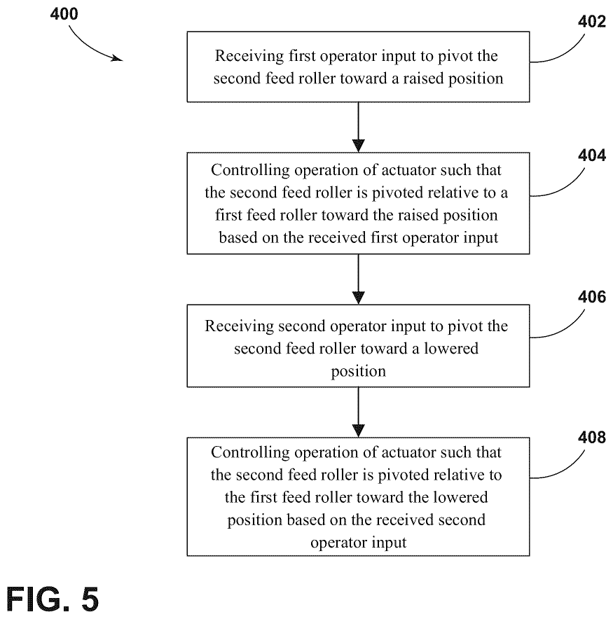

Referring now to FIG. 5, a flow diagram of one embodiment of a method 400 for controlling the operation of an agricultural harvester is illustrated in accordance with aspects of the present subject matter. In general, the method 400 will be described herein with reference to the agricultural harvester 10 and the system 200 described above with reference to FIGS. 1-4. However, it should be appreciated by those of ordinary skill in the art that the disclosed method 400 may generally be implemented with any agricultural harvester having any suitable harvester configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (402), the method 400 includes receiving, with a computing system, a first operator input to pivot the second feed roller toward a raised position. Specifically, as mentioned above, in several embodiments, the computing system 210 is communicatively coupled to the input device(s) 220 via the communicative link 202. In this respect, the computing system 210 may be configured to receive the first operator input to pivot the second spiral feed roller 32B toward the raised position 94A.

Furthermore, at (404), the method 400 includes controlling, with the computing system, an operation of an actuator configured to pivot the second feed roller relative to a first feed roller between a lowered position and the raised position such that the second feed roller is pivoted toward the raised position based on the received first operator input. Specifically, as mentioned above, in several embodiments, the computing system 210 may be communicatively coupled to the actuator(s) 88 via the communicative link 202. In this respect, the computing system 210 may be configured to control the operation of the actuator(s) 88 such that the second spiral feed roller 32B is pivoted relative to the first spiral feed roller 32A toward the raised position 94A based on the received first operator input.

Additionally, at (406), the method 400 includes receiving, with the computing system, a second operator input to pivot the second feed roller toward the lowered position. Specifically, in several embodiments, the computing system 210 may be configured to receive the second operator input to pivot the second spiral feed roller 32B toward the lowered position 94B.

Moreover, at (408), the method 400 includes controlling, with the computing system, the operation of the actuator such that the second feed roller is pivoted relative to the first feed roller toward the lowered position based on the received second operator input. Specifically, in several embodiments, the computing system 210 may be configured to control the operation of the actuator(s) 88 such that the second spiral feed roller 32B is pivoted relative to the first spiral feed roller 32A toward the lowered position 94B based on the received second operator input.

It is to be understood that the steps of the control logic 300 and the method 400 are performed by the computing system 210 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 210 described herein, such as the control logic 300 and the method 400, is implemented in software code or instructions which are tangibly stored on a tangible computer readable medium. The computing system 210 loads the software code or instructions via a direct interface with the computer readable medium or via a wired and/or wireless network. Upon loading and executing such software code or instructions by the computing system 210, the computing system 210 may perform any of the functionality of the computing system 210 described herein, including any steps of the control logic 300 and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural harvester, comprising:
a chassis;
a forward frame supported on the chassis;
a cutter assembly supported on the forward frame and configured to sever crop material as the agricultural harvester traverses a field;
a divider shoe coupled to the forward frame and configured to direct the crop material toward the cutter assembly as the agricultural harvester traverses the field;
a first feed roller coupled to the forward frame;
a second feed roller extending between a first end and a second end, the first end of the second feed roller pivotably coupled to the divider shoe such that a position of the second feed roller is adjustable relative to the first feed roller, the second feed roller configured to operate in conjunction with the first feed roller to direct the crop material toward the cutter assembly as the agricultural harvester traverses the field; and
an actuator coupled between the second feed roller and the forward frame and configured to adjust the position of the second feed roller relative to the first feed roller to control a quantity of the crop material that is directed toward the cutter assembly.

2. The agricultural harvester of claim 1, wherein an operation of the actuator is selectively controlled to adjust the position of the second feed roller relative to the first feed roller.

3. The agricultural harvester of claim 1, wherein:
the second feed roller is coupled to the divider shoe at a pivot joint, the second feed roller configured to pivot about the pivot joint relative to the first feed roller; and
when adjusting the position of the second feed roller, the actuator is configured to pivot the second feed roller about the pivot joint between a lowered position and a raised position.

4. The agricultural harvester of claim 3, wherein:
when the second feed roller is pivoted about the pivot joint toward the raised position, the quantity of the crop material that is directed toward the cutter assembly is increased.

5. The agricultural harvester of claim 3, wherein:
when the second feed roller is pivoted about the pivot joint toward the lowered position, the quantity of the crop material that is directed toward the cutter assembly is decreased.

6. The agricultural harvester of claim 1, wherein:
the first feed roller is fixed relative to the forward frame such that an angular orientation of the first feed roller relative to the forward frame is fixed.

7. The agricultural harvester of claim 1, further comprising:
an input device configured to control an operation of the actuator based on a received operator input.

8. The agricultural harvester of claim 1, further comprising:
an input device configured to receive an operator input to control an operation of the actuator; and
a computing system communicatively coupled to the input device, the computing system configured to control the operation of the actuator based on the received operator input.

9. The agricultural harvester of claim 1, wherein the actuator comprises a fluid-filled actuator.

10. The agricultural harvester of claim 1, wherein:
the actuator extends between a first end and a second end, the second end of the actuator coupled to the forward frame and the first end of the actuator coupled to the second feed roller between the second end of the second feed roller and a position on the second feed roller halfway between the first end of the second feed roller and the second end of the second feed roller.

11. A harvesting assembly of an agricultural harvester, the harvesting assembly comprising:
a cutter assembly configured to sever crop material as the agricultural harvester traverses a field;
a divider shoe configured to direct the crop material toward the cutter assembly as the agricultural harvester traverses the field;
a first feed roller;
a second feed roller extending between a first end and a second end, the first end of the second feed roller pivotably coupled to the divider shoe such that a position of the second feed roller is adjustable relative to the first feed roller, the second feed roller configured to operate in conjunction with the first feed roller to direct the crop material toward the cutter assembly as the agricultural harvester traverses the field; and
an actuator coupled between the second feed roller and a forward frame of the agricultural harvester, the actuator configured to adjust the position of the second feed roller relative to the first feed roller to control a quantity of the crop material that is directed toward the cutter assembly.

12. The harvesting assembly of claim 11, wherein an operation of the actuator is selectively controlled to adjust the position of the second feed roller relative to the first feed roller.

13. The harvesting assembly of claim 11, wherein:
the second feed roller is coupled to the divider shoe at a pivot joint, the second feed roller configured to pivot about the pivot joint relative to the first feed roller; and
when adjusting the position of the second feed roller, the actuator is configured to pivot the second feed roller about the pivot joint between a lowered position and a raised position.

14. The harvesting assembly of claim 13, wherein:
when the second feed roller is pivoted about the pivot joint toward the raised position, the quantity of the crop material that is directed toward the cutter assembly is increased.

15. The harvesting assembly of claim 13, wherein:
when the second feed roller is pivoted about the pivot joint toward the lowered position, the quantity of the crop material that is directed toward the cutter assembly is decreased.

16. The harvesting assembly of claim 11, wherein:
the first feed roller is fixed relative to the forward frame such that an angular orientation of the first feed roller relative to the forward frame is fixed.

17. The harvesting assembly of claim 11, further comprising:
an input device configured to control an operation of the actuator based on a received operator input.

18. The harvesting assembly of claim 11, further comprising:
an input device configured to receive an operator input to control an operation of the actuator; and
a computing system communicatively coupled to the input device, the computing system configured to control the operation of the actuator based on the received operator input.

19. The harvesting assembly of claim 11, wherein the actuator comprises a fluid-filled actuator.

20. A method of controlling the operation of an agricultural harvester, the agricultural harvester including a divider shoe configured to direct crop material toward a cutter assembly as the agricultural harvester traverses a field, a first feed roller, and a second feed roller extending between a first end and a second end, the first end of the second feed roller pivotably coupled to the divider shoe such that a position of the second feed roller is adjustable relative to the first feed roller, the method comprising:
receiving, with a computing system, a first operator input to pivot the second feed roller toward a raised position;
controlling, with the computing system, an operation of an actuator configured to pivot the second feed roller relative to the first feed roller between a lowered position and the raised position such that the second feed roller is pivoted toward the raised position based on the received first operator input;
receiving, with the computing system, a second operator input to pivot the second feed roller toward the lowered position; and
controlling, with the computing system, the operation of the actuator such that the second feed roller is pivoted relative to the first feed roller toward the lowered position based on the received second operator input.
